(19) United States
(12) Patent Application Publication
(10) Pub. No.: US 2009/0079787 A1
(43) Pub. Date: Mar. 26, 2009

(54) DROPLET EJECTING APPARATUS

(75) Inventor: Takaichiro Umeda, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/233,582

(22) Filed: Sep. 18, 2008

(30) Foreign Application Priority Data
Sep. 21, 2007 (JP) 2007245820

(51) Int. Cl. B41J 2/165

(52) U.S. Cl. 347/30

(57) ABSTRACT

A droplet ejecting apparatus includes: a droplet ejecting head having at least one nozzle; a liquid supply passage for supplying liquid to the droplet ejecting head; an exhaust passage communicable with the liquid supply passage to exhaust bubbles in the liquid supply passage; an on-off valve which selectively opens or closes an communication passage provided between the liquid supply passage and the exhaust passage; an exhaust cap which fluid-tightly closes one opening of the communication passage close to the exhaust passage, and which is connected to one end of the exhaust passage close to the communication passage; a suction device connected to the other end of the exhaust passage; a switching device which indirectly operates the on-off valve through the exhaust cap from an outside thereof to selectively open or close the on-off valve; and a control device which controls the droplet ejecting head, the suction device, and the switching device.

### CROSS REFERENCE TO RELATED APPLICATION

The present application claims priority from Japanese Patent Application No. 2007-245820, which was filed on Sep. 21, 2007, the disclosure of which is herein incorporated by reference in its entirety.

### BACKGROUND OF THE INVENTION

1. Field of the Invention

The present invention relates to a droplet ejecting apparatus that ejects a droplet of a liquid.

2. Discussion of Related Art

There is conventionally known an inkjet recording apparatus as a droplet ejecting apparatus that ejects a droplet of a liquid, which records an image (including letters) on a recording medium such as a recording sheet by ejection of a droplet of ink through a nozzle toward the recording medium. The inkjet recording apparatus generally includes an inkjet head (a droplet ejecting head) which has a plurality of nozzles and an ink cartridge (ink cartridges) as an ink supply source which is connected to the inkjet head. In the inkjet head, when ink is consumed by ejection of the droplet of ink through the plurality of nozzles, ink is supplied to the inkjet head from the ink cartridge.

In a passage (an ink supply passage) through which the inkjet head and the ink cartridge are connected to each other, it is likely to happen that air bubbles are put into the passage from an outside, caused by an air intrusion during changing of the ink cartridge and an air permeating through an ink supply tube (a flexible tube) that forms an ink supply passage. When the air bubbles in the ink supply passage flow into the inkjet head along with the ink, it is possible to cause a malfunction of ejecting of ink through the nozzles. Therefore, there has been proposed the inkjet recording head in which the air bubbles that are put into the ink supply passage are exhausted through another passage (an exhaust passage) that is in communication with the ink supply passage.

For example, JP-A-2005-271554 discloses an inkjet recording apparatus, which includes (1) a buffer tank which is in communication with the inkjet recording head and the ink cartridge and temporarily accommodates ink, (2) a diverging passage which diverges from the buffer tank, (3) an exhaust valve which selectively opens or closes the diverging passage, (4) a cap member which is movable between a capping position so as to cover an opening of the diverging passage and a waiting position to be retracted from the opening thereof, and (5) a suction pump which is connected to the cap member via a tube. When the cap member is moved from the waiting position to the capping position, a projecting portion that is disposed in the cap member presses a valve element of the exhaust valve against a biasing force by a spring member, so that the diverging passage is opened. In other words, the buffer tank and an inner space of the cap member come to be in communication with each other. In this state, when air in the inner space of the cap member is sucked by the suction pump through the tube such that a pressure in the inner space of the cap member is decreased, air bubbles that remain in the buffer tank are exhausted from the diverging passage to the cap member.

In the inkjet recording apparatus disclosed in JP-A-2005-271554, during sucking of air by the suction pump, not only the air bubbles but also inks that are accommodated in the buffer tank are sucked from the buffer tank. Therefore, after sucking of air by the suction pump is ended, when the cap member is moved from the capping position to the waiting position that is apart from the opening of the diverging passage, it is possible to happen that inks that are stuck to the vicinity of the opening of the diverging passage and/or the cap member are spread around the cap member.

### SUMMARY OF THE INVENTION

It is therefore an object of the present invention to provide a droplet ejecting apparatus that can prevent a liquid including air bubbles, which is sucked and exhausted from a liquid supply passage, from being spread around after sucking of the liquid is ended.

The above-mentioned object may be achieved according to any one of the following modes of the present invention in the form of the droplet ejecting apparatus, each of which is numbered like the appended claims and may depend from the other mode or modes, where appropriate, to indicate and clarify possible combinations of technical features. It is, however, to be understood that the present invention is not limited to the technical features or any combinations thereof that will be described below for illustrative purposes only. It is to be further understood that a plurality of features included in any one of the following modes of the invention are not necessarily provided altogether, and that the invention may be embodied without employing at least one of the features described in connection with each of the modes.

(1) A droplet ejecting apparatus comprising:

a droplet ejecting head which has at least one nozzle through which a droplet of a liquid is ejected;

a liquid supply passage for supplying the liquid to the droplet ejecting head;

an exhaust passage which is communicable with the liquid supply passage to exhaust bubbles in the liquid supply passage;

an on-off valve which selectively opens or closes an communication passage that is provided between the liquid supply passage and the exhaust passage;

an exhaust cap which fluid-tightly closes one of opposite openings of the communication passage that is close to the exhaust passage, and which is connected to one of opposite ends of the exhaust passage that is close to the communication passage;

a suction device which is connected to an other end of the exhaust passage;

a switching device which indirectly operates the on-off valve through the exhaust cap from an outside thereof to selectively open or close the on-off valve; and

a control device which controls the droplet ejecting head, the suction device, and the switching device.

In the present droplet ejecting apparatus, the one of the opposite openings of the communication passage through which the liquid supply passage and the exhaust passage are communicable with each other is always closed by the exhaust cap, and the on-off valve which selectively opens or closes the communication passage is selectively opened or closed by the switching device through the exhaust cap. Therefore, a liquid including air (bubbles) is sucked and exhausted by the suction device from the liquid supply passage through the communication passage and is received by the exhaust cap that covers the communication passage. Since the exhaust cap fluid-tightly closes the one of the opposite openings of the communication passage, the liquid that is exhausted along with the air is prevented from spreading around.

(2) The droplet ejecting apparatus according to the mode (1), wherein the exhaust cap has a flexibility and is bent such that the switching device is allowed to operate the on-off valve.

In the present droplet ejecting apparatus, the exhaust cap can be easily deformed, so that the on-off valve can be surely opened or closed by the switching device even through the exhaust cap.

(3) The droplet ejecting apparatus according to the mode (2),

wherein the on-off valve includes:

a valve housing which has the communication passage and a valve seat that is provided in the communication passage;

a valve element which can be seated on or lifted from the valve seat;

an elastic member which biases the valve element in a direction in which the valve element is seated on the valve seat; and

a valve rod which extends from the valve element, and

wherein the switching device operates the valve rod through the exhaust cap to move against an elastic force by the elastic member so as to open the on-off valve.

The valve rod may be operated such that the valve rod is pressed against the elastic force by the elastic member in an axis direction of the valve rod, or such that the valve rod is leaned and a part of the valve element is lifted (retracted) from the valve seat.

(4) The droplet ejecting apparatus according to the mode (3), wherein the valve rod protrudes from the one of opposite openings of the communication passage.

(5) The droplet ejecting apparatus according to the mode (3) or the mode (4), wherein the exhaust cap consists of a membranous member whose peripheral portion is fluid-tightly fixed to a peripheral portion of a surface in which the one of opposite openings of the communication passage that is provided in the valve housing of the on-off valve is opened.

In the present mode, the exhaust cap can be simply structured.

(6) The droplet ejecting apparatus according to any of the modes (3) through (5), wherein the switching device includes:

a pressing portion which is opposed to the valve rod through the exhaust cap; and

a driving portion which has the pressing portion move between an opening valve position to press the valve rod so as to open the on-off valve and a closing valve position to be retracted from the valve rod so as to close the on-off valve.

(7) The droplet ejecting apparatus according to any of the modes (1) through (6),

wherein the control device has a first suction mode, and

wherein in the first suction mode, the switching device operates the on-off valve from an outside of the exhaust cap to open the communication passage,

and next, the bubbles in the liquid supply passage are sucked by the suction device through the exhaust passage to be discharged into the exhaust cap, and then, the switching device operates the on-off valve from the outside of the exhaust cap to close the communication passage.

(8) The droplet ejecting apparatus according to the mode (7), wherein the control device further has a second suction mode in which, in a state in which the communication passage is closed by the on-off valve after implementing of the first suction mode, a liquid that remains in the exhaust cap is sucked by the suction device.

According to the present mode, in a state in which the communication passage is closed by the on-off valve after the liquid including bubbles is exhausted from the liquid supply passage to the exhaust cap in the first suction mode, the second suction mode is implemented, so that the liquid that remains in the exhaust cap can be sucked by the suction device.

(9) The droplet ejecting apparatus according to the mode (8), wherein a suction amount by the suction device in the second suction mode that is implemented in the state in which the communication passage is closed by the on-off valve is larger than the suction amount in the first suction mode that is implemented in a state in which the communication passage is open.

In the first suction mode that is implemented in the state in which the communication passage is opened by the on-off valve, when the suction amount by the suction device is made too large, a meniscus that is formed in the at least one nozzle of the droplet ejecting head which is in communication with the liquid supply passage via the communication passage is possible to be broken. However, in the second suction mode in which the communication passage is closed by the on-off valve, the above-mentioned problem cannot occur even when the suction amount is made large such that the liquid remainder in the exhaust cap is surely exhausted. Therefore, the suction amount in the second suction mode is made larger than the suction amount in the first suction mode.

(10) The droplet ejecting apparatus according to any of the modes (1) through (9), further comprising an atmosphere communication portion which has an exhaust-passage-side space that is a space disposed in a side of the exhaust passage relative to the on-off valve communicate with an atmosphere, and

wherein the atmosphere communication portion includes a leaking-preventing portion which prevents a liquid in the exhaust-passage-side space from leaking to the atmosphere.

According to the present mode, when the second suction mode is implemented, the liquid that remains in the exhaust cap can be surely sucked and exhausted while air of the atmosphere flows into the exhaust cap from the atmosphere communication portion. Further, since the atmosphere communication portion includes the leaking-preventing portion, the liquid is prevented from leaking from the atmosphere communication portion to the atmosphere.

(11) The droplet ejecting apparatus according to the mode (10), wherein the leaking-preventing portion includes an air permeating film which permits an air to permeate therethrough and prevents a liquid from permeating therethrough.

(12) The droplet ejecting apparatus according to the mode (10) or the mode (11), wherein the leaking-preventing portion includes a one-way valve which permits air of the atmosphere to flow into an inside of the exhaust-passage-side space from the outside thereof and prevents the air and the liquid from flowing out in a direction from the inside of the exhaust-passage-side space to the outside thereof.

(13) The droplet ejecting apparatus according to any of the modes (1) through (12), wherein the exhaust cap is located at a position higher than a position of a droplet ejecting opening of the nozzle.

When the exhaust cap that always closes the one of the opposite openings of the communication passage is located at a height position lower than that of the droplet ejecting opening of the at least one nozzles an object to which the droplet of the liquid is ejected through the nozzle is possible to come into contact with the exhaust cap. In order to prevent the above-mentioned problem, the exhaust cap is needed to be located at a position apart from the droplet ejecting head. In this case, the droplet ejecting apparatus becomes large-sized. Further, in a case where the liquid that is stuck to a surface in which the droplet ejecting opening of the nozzle is located (a droplet ejecting surface) is wiped off by a wiper, the wiper comes into contact with the exhaust cap after wiping the droplet ejecting surface and the liquid is stuck to an outer surface of the exhaust cap. Furthermore, there is a possibility that the liquid which is stuck to the exhaust cap through the wiper is stuck to surroundings of the apparatus. However, in the present mode, the exhaust cap is located at the position higher than the position of the droplet ejecting opening, so that the above-mentioned problems do not occur.

(14) The droplet ejecting apparatus according to any of the modes (1) through (13),

wherein the liquid supply passage includes a liquid reservoir chamber which accommodates the liquid, and

wherein the exhaust passage is communicable with the liquid supply passage through the communication passage that diverges from an upper portion of the liquid reservoir chamber.

Air bubbles that are mingled with the liquid in the liquid supply passage tend to be gathered in the upper portion of the liquid reservoir chamber that forms a part of the liquid supply passage. Since the upper portion of the liquid reservoir chamber is communicable with the exhaust passage through the communication passage and the exhaust cap, the large bubbles that remain in the upper portion of the liquid reservoir chamber can be easily exhausted to the exhaust cap through the communication passage.

(15) The droplet ejecting apparatus according to any of the modes (1) through (14), further comprising a medium feeding device which feeds a recording medium, and

wherein the droplet ejecting head has a plurality of nozzles, and

wherein by ejection of the droplet through the plurality of nozzles, an image is recorded on the recording medium which is fed by the medium feeding device.

(16) The droplet ejecting apparatus according to the mode (15), further comprising a head moving device which has the droplet ejecting head move in a direction perpendicular to a direction of feeding of the recording medium by the medium feeding device, and

wherein the on-off valve and the exhaust cap are moved by the head moving device along with the droplet ejecting head, and the suction device is provided in a fixed position,

wherein the exhaust cap and the suction device are always connected to each other through a flexible tube that is elastically deformable with moving of the exhaust cap, and

wherein the flexible tube forms at least a part of the exhaust passage.

While the suction device is maintained at the fixed position, the exhaust cap is moved with the droplet ejecting head by the head moving device. Since the exhaust cap is connected to the suction device via the flexible tube, it is not necessary that the exhaust cap is put into contact with the vicinity of the one of the opposite openings of the communication passage and is separated from the vicinity of the opening of the communication passage as in a conventional image recording apparatus, so that it is surely prevented that the liquid is spread around the opening of the communication passage.

(17) The droplet ejecting apparatus according to the mode (16), wherein the switching device is provided in a maintenance position that is apart from a recording area in which an image recording is performed by the droplet ejecting head.

### BRIEF DESCRIPTION OF THE DRAWINGS

The above and optional objects, features, and advantages of the present invention will be better understood by reading the following detailed description of the preferred embodiments of the invention when considered in conjunction with the accompanying drawings, in which;

FIG. 1 is a plan view schematically showing a structure of a printer as one embodiment (a first embodiment) to which the present invention is applied;

FIG. 2 is a vertical cross-sectional view showing a part of an inkjet head of the printer;

FIG. 3 is a vertical cross-sectional view showing a sub tank that is positioned in a recording area;

FIG. 4 is a cross-sectional view taken along line 4-4 of an exhaust unit of the sub tank shown in FIG. 3;

FIG. 5 is a vertical cross-sectional view showing a sub tank that is positioned at a maintenance position;

FIG. 6 is a cross-sectional view taken along line 6-6 of the exhaust unit shown in FIG. 5;

FIG. 7 is a block diagram schematically showing an electric structure of the printer shown in FIG. 1;

FIG. 8 is a vertical cross-sectional view showing an exhaust unit of a sub tank of a printer as another embodiment (a second embodiment) to which the present invention is applied;

FIG. 9 is a cross-sectional view of an atmosphere communication portion of the printer shown in FIG. 8;

FIG. 10 is a vertical cross-sectional view showing an exhaust unit of a sub tank of a printer as another embodiment (a third embodiment) to which the present invention is applied;

FIG. 11 is a plan view schematically showing a structure of a printer as another embodiment (a forth embodiment) to which the present invention is applied; and

FIG. 12 is a vertical cross-sectional view showing an exhaust unit of a sub tank of a printer as another embodiment (a fifth embodiment) to which the present invention is applied.

### DESCRIPTION OF THE EMBODIMENTS

Hereinafter, there will be described preferred embodiments of the present invention with reference to the drawings. As one embodiment of the present invention, the present invention is applied to a printer which records (prints) desired letters, images, and the like on a recording sheet by ejection of droplets of ink toward the recording sheet from an inkjet head.

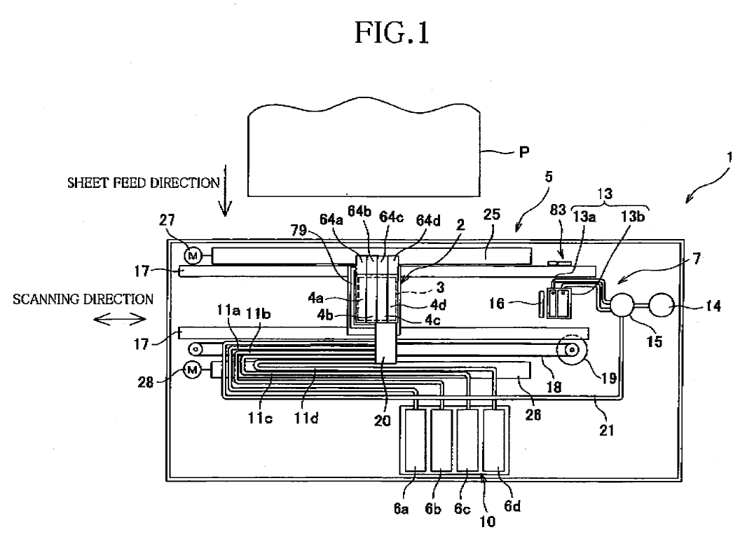

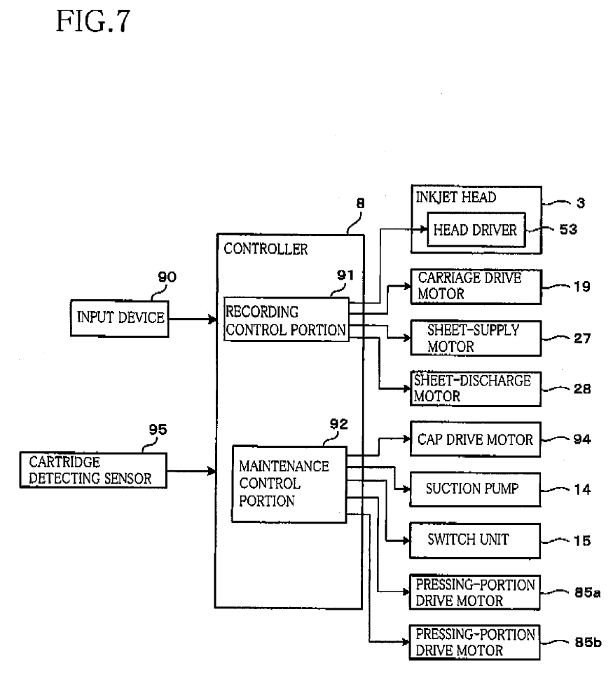

As shown in FIG. 1, a printer 1 as a droplet ejecting apparatus includes: (1) a carriage 2 which is reciprocateable along one direction; (2) an inkjet head 3 or a printhead 3 as a droplet ejecting head which is carried by the carriage 2; (3) a plurality of sub tanks 4a through 4d; (4) a feeding device 5 which feeds the recording sheet P in a sheet feed direction shown in FIG. 1; (5) a plurality of ink cartridges 6a through 6d which accommodate respective colors of inks; (6) a maintenance device 7 which has the inkjet head 3 recover from a decrease in a droplet-ejecting performance thereof, and (7) a control device 8 (shown in FIG. 7) or a controller 8 which controls respective parts of the printer 1.

The carriage 2 is reciprocateable along two (a pair of) guide rods 17 each of which extends in a (main) scanning direction, a direction perpendicular to the sheet feed direction, or a left-right direction in FIG. 1. Further, since the carriage 2 is attached to an endless belt 18, when the endless belt 18 is driven or rotated by a carriage drive (CR) motor 19, the carriage 2 is moved (reciprocated) in the scanning direction with circulating of the endless belt 18.

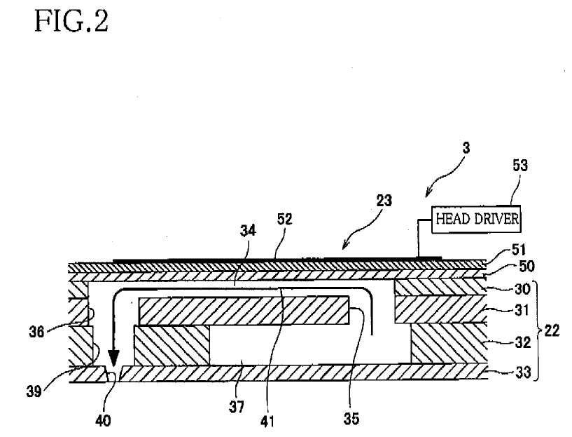

The carriage 2 carries the inkjet head 3 and the plurality (four) of sub tanks 4a through 4d. The inkjet head 3 ejects the droplets of ink toward each of a plurality of recording sheets P that are fed by the feeding device 5 in the sheet feed direction or in a downward direction in FIG. 1 through a plurality of nozzles 40 (shown in FIG. 2) that are provided in a lower surface of the inkjet head 3, while the inkjet head 3 reciprocates in the scanning direction along with the carriage 2. The desired letters or/and images are thus recorded on each of the recording sheets P.

The four sub tanks 4a through 4d are respectively arranged along the scanning direction. A tube joint 20 is integrally disposed with the four sub tanks 4a through 4d. The four sub tanks 4a through 4d and the four ink cartridges 6a through 6d are respectively connected to each other through corresponding flexible tubes 11a through 11d that are connected to the tube joint 20. Further, in one of opposite end portions in the sheet feed direction of each of the four sub tanks 4a through 4d, there is provided a respective one of four exhaust units 64a through 64d for exhausting air bubbles that remain in each of the sub tanks 4a through 4d. The exhaust units 64a through 64d will be described in detail later.

The feeding device 6 includes a sheet-supply roller 25 which is disposed on an upstream side of the printer 1 with respect to the inkjet head 3 in the sheet feed direction, and a sheet-discharge roller 26 which is disposed on a downstream side of the printer 1 with respect to the inkjet head 3 in the sheet feed direction. The sheet-supply roller 25 and the sheet-discharge roller 26 are driven or rotated by a sheet-supply motor 27 and the sheet-discharge motor 28, respectively. In the feeding device 5, the recording sheet P is supplied or fed to be opposed to the inkjet head 3 in the sheet feed direction from upward (an upper portion of the printer 1) in FIG. 1 by the sheet-supply roller 25, and the recording sheet P on which images are recorded by the inkjet head 3 is discharged downward (to a lower portion of the printer 1) in FIG. 1 by the sheet-discharge roller 26.

The four ink cartridges 6a through 6d accommodate four colors of inks such as black (B), yellow (Y), cyan (C), and magenta (M) inks, respectively. The four ink cartridges 6a through 6d are freely attachable to and detachable from a holder 10. In the holder 10, cartridge detecting sensors 95 (not shown in FIG. 1 but shown in FIG. 7) are provided for detecting whether the ink cartridges Ga through 6d are attached to the holder 10. In the present embodiment, for example, each of the cartridge detecting sensors 95 is an optical sensor which has a light emitting element and a light receiving element and which detects that each of the ink cartridges 6a through 6d is in an attached state to the holder 10 when a light emitted from the light emitting element is intercepted by the each of the ink cartridges 6a through 6d. The cartridge detecting sensor 95 may be contact-type sensor which detects a state of attachment of each of the ink cartridges 6a through 6d to the holder 10 when the each of the ink cartridges 6a through 6d is attached to the holder 10 and a pair of contact points disposed on a side of the holder 10 and a pair of contact points disposed on a side of the each of ink cartridges 6a through 6d are held in contact with each other such that the contact points are electrically conducted to each other.

After the four inks that are respectively stored in the four ink cartridges 6a through 6d are temporarily stored in the sub tanks 4a through 4d, respectively, the four inks are supplied to the inkjet head 3. The four sub tanks 4a through 4d, and tubes 11a through 11d through which the four sub tanks 4a through 4d and the four ink cartridges 6a through 6d are connected to each other constitute an ink supply passage (a liquid supply passage) for supplying the four colors of inks to the inkjet head 3.

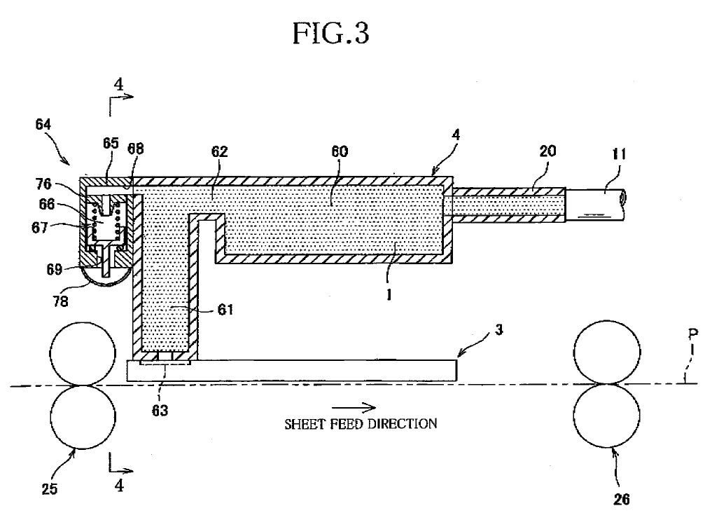

The maintenance device 7 is disposed at an area (a maintenance position or a fixed position) that is within an area of movement of the carriage 2 in the scanning direction and is outside (in a right-hand side in FIG. 1), or is apart from a recording area in which the inkjet head 3 (the carriage 2) is opposed to the recording sheet P. The maintenance device 7 includes: (1) a suction cap 13 which can fluid-tightly cover (or be held in close contact with) a droplet ejecting surface (a lower surface) of the inkjet head 3; (2) a suction pump 14 as a suction device which is connected to the suction cap 13 and the exhaust units 64a through 64d; (3) a wiper 16 which wipes off ink that is stuck to the droplet ejecting surface of the inkjet head 3; and (4) a valve operating device 83 as a switching device which operates respective on-off valves 67 (shown in FIGS. 3 through 6) of the exhaust units 64a through 64d that are provided in the sub tanks 4a through 4d.

When the carriage 2 is moved to the maintenance position in order to recover a performance of droplet ejecting by the inkjet head 3, the suction cap 13 is opposed to the lower surface or the droplet ejecting surface on which the plurality of nozzles 40 are arranged. Then, the suction cap 13 is driven to move upward (in a front side of a sheet plane of FIG. 1) by a cap drive motor 94 (shown in FIG. 7) and fluid-tightly covers the droplet ejecting surface of the inkjet head 3 so as to fluid-tightly cover the plurality of nozzles 40 of the inkjet head 3.

The suction cap 13 is connected to the suction pump 14 through a switch unit 15. When the suction pump 14 is operated in a state in which the suction cap 13 fluid-tightly covers the plurality of nozzles 40 that are arranged in the lower surface of the inkjet head 3, inks are sucked and exhausted through the nozzles 40. Therefore, inks in the nozzles 40 that increase viscosity due to drying thereof and air bubbles that remain in the inkjet head 3 can be removed from the inkjet head 3 through the nozzles 40. Further, after the inks are removed from the inkjet head 3 through the nozzles 40, the inkjet head 3 is moved in the scanning direction relative to the wiper 16, so that inks that are stuck to the droplet ejecting surface of the inkjet head 3 are wiped off by the wiper 16.

In the present embodiment, as shown in FIG. 1, the auction cap 13 includes a first cap portion 13a which covers the plurality of nozzles 40 that eject the black ink and a second cap portion 13b which covers the respective nozzles 40 that eject a corresponding one of three colors of inks such as the yellow, magenta, and cyan inks, and the first cap portion 13a and the second cap portion 13b are apart from each other. The first cap portion 13a and the second cap portion 13b are respectively connected to the switch unit 15, and the switch unit 15 is connected to the suction pump 14. The switch unit 15 includes a valve which is controlled by a signal transmitted (outputted) from the control device 8 and switches from one of the first, second cap portions 13a, 13b to another thereof as a destination to which the suction pump 14 is connected. Accordingly, since the switch unit 15 switches from one of the first, second cap portions 13a, 13b to another thereof, either one of the nozzles 40 that eject the black ink and the nozzles 40 that eject one of the three colors of inks can be selected such that the inks are sucked through the nozzles 40.

Furthermore, the switch unit 15 is connected to the exhaust tube 21 that is connected to the exhaust units 64a through 64d of the sub tanks 4a through 4d as mentioned later Therefore, as the destination to which the suction pump 14 is connected, either one of the exhaust units 64a through 64d, and the first, second cap portions 13a, 13b of the suction cap 13 can be selected by the switch unit 15. In a state in which the exhaust units 64a through 64d are connected to the suction pump 14, the suction pump 14 is operated after the on-off valves 67 that are provided in the exhaust units 64a through 64d are opened by the valve operating device 83, so that the air bubbles that remain in the sub tanks 4a through 4d can be sucked and exhausted (removed) by the suction pump 14 via the exhaust units 64a through 64d and the exhaust tube 21. Structures of the exhaust units 64a through 64d and the valve operating device 83 will be described in detail later.

Hereinafter, a structure of the inkjet head 3 will be described. As shown in FIG. 2, the inkjet head 3 includes a passage unit 22 in which an ink passage including the nozzles 40 and a plurality of pressure chambers 84 is formed, and a piezoelectric actuator 23 for ejecting inks through the nozzles 40 of the passage unit 22 by applying of a pressure to inks in the pressure chambers 34.

The passage unit 22 includes a cavity plate 30, a base plate 31 and a manifold plate 32 each of which is formed of a metallic material such as stainless steel, and a nozzle plate 33 that is formed of an insulating (a dielectric) material, e.g., a high polymer synthetic resin such as polyimide. The passage unit 22 has a laminar structure including the plates 30 through 33 that are stacked on and adhered to each other.

In the cavity plate 30, the plurality of pressure chambers 34 are formed. The plurality of pressure chambers 34 are arranged in a direction perpendicular to a sheet plane of FIG. 2. In the base plate 31, communication holes 35, 36 that are in communication with respective one of the pressure chambers 34 are formed. In the manifold plate 32, there are formed a manifold 37 that is in communication with the plurality of pressure chambers 34 through the communication hole 35, and a communication hole 39 that is in communication with the communication hole 36. In the nozzle plate 33, the plurality of nozzles 40 are formed, and the nozzles 40 are arranged in the direction perpendicular to the sheet plane of FIG. 2 corresponding to the plurality of pressure chambers 34. Further, in the passage unit 22, a plurality of individual ink passages 41 each of which extends from the manifold 37 to the nozzle 40 via the pressure chamber 34.

The piezoelectric actuator 23 includes: (1) a metallic oscillating plate 50 which is adhered to an upper surface of the passage unit 22 so as to cover the plurality of the pressure chambers 34; (2) a piezoelectric layer 51 which is disposed on an upper surface of the oscillating plate 50; and (3) a plurality of individual electrodes 52 which are formed on an upper surface of the piezoelectric layer 51.

The metallic oscillating plate 50 is always kept at a ground potential by a head driver 53. The piezoelectric layer 51 is formed of a lead-zirconate-titanate (PZT)-based piezoelectric material that is composed of solid solution of lead titanate and lead zirconate and that has ferroelectricity, and is arranged on the upper surface of the oscillating plate 50 so as to extend over the plurality of pressure chambers 34. Each of the plurality of individual electrodes 52 is disposed at an area of the upper surface of the piezoelectric layer 51 that is opposed to a central portion of each of the plurality of pressure chambers 34. By the head driver 53, either one of a ground potential and a predetermined electric voltage that is different from the ground potential is applied to the plurality of individual electrodes 52.

There will be described an action of the piezoelectric actuator unit 23 when an ink ejection is performed. When a droplet of ink is ejected through one of the nozzles 40, a drive voltage is applied from the head driver 53 to one of the plurality of the individual electrodes 52 corresponding to the pressure chamber 34 that is in communication with the nozzle 40. At the time, a difference in electric potential is generated between the individual electrode 52 to which the drive voltage is applied and the oscillating plate 50 which is kept at the ground potential, so that an electric field parallel to a direction of thickness of the piezoelectric layer 51 is applied to the piezoelectric layer 51 interposed between the individual electrode 52 and the oscillating plate 50. In a case where a polarization direction of the piezoelectric layer 51 is identical with a direction in which the electric field is applied thereto, the piezoelectric layer 51 extends in the direction of thickness thereof and contracts in a direction parallel to a plane of the piezoelectric layer 51. According to the above-mentioned contraction of the piezoelectric layer 51, an opposed area of the oscillating plate 50 that is opposed to the pressure chamber 34 is deformed into a convex shape toward the corresponding pressure chamber 34, so as to constitute a piezoelectric unimorph. At this time, a volume of the pressure chamber 34 is decreased to apply an intense pressure to ink accommodated in the pressure chamber 34, so that the ink is ejected through the nozzle 40 in communication with the pressure chamber 34.

Next, the sub tanks 4a through 4d each of which supplies ink to the inkjet head 3 will be described with reference to FIG. 3. Since the sub tanks 4a through 4d have basically the identical structure with each other, hereinafter, one of the sub tanks 4a through 4d will be representatively described and is referred to as “the sub tank 4” when required. Under the same reason, representative one of the ink cartridges 6a through 6d and representative one of the tubes 11a through 11d corresponding to the sub tanks 4a through 4d will be referred to as “the ink cartridge 6” and “the tube 11”, respectively.

As shown in FIG. 3, the sub tank 4 is formed of a material such as a synthetic resin. In the sub tank 4, there are disposed an ink reservoir chamber 60 as a liquid reservoir chamber which extends in a horizontal direction and a vertical passage 61 which is in communication with the ink reservoir chamber 60 and the inkjet head 3.

The ink reservoir chamber 60 is communicated with the corresponding ink cartridge 6 (shown in FIG. 1) via the corresponding tube 11 that is connected to the tube joint 20 and temporarily accommodates ink (shown as a reference numeral “I” in FIG. 3) that is supplied from the ink cartridge 6.

An upper end portion of the vertical passage 61 is located at substantially the same height position with that of an outlet of the ink reservoir chamber 60 which extends in a horizontal direction. The upper end portion of the vertical passage 61 and the outlet of the ink reservoir chamber 60 are communicated with each other through a communication passage 62 extending horizontally. Further, a lower end portion of the vertical passage 61 is connected to the inkjet head 3. In an connection opening of the inkjet head 3 through which the same 3 is connected to the sub tank 4, there is disposed a filter 63 for removing dusts and so on that are mingled with ink flowing from the sub tank 4 to the inkjet head 3.

The ink that is supplied from the ink cartridge 6 to the sub tank 4 via the tube 11 is temporarily accommodated in the ink reservoir chamber 60, and then flows out horizontally from the outlet of the same 60 to the vertical passage 61 through the communication passage 62. After that, in the vertical passage 61, the ink flows downward to pass through the filter 63 and is supplied to the inkjet head 3.

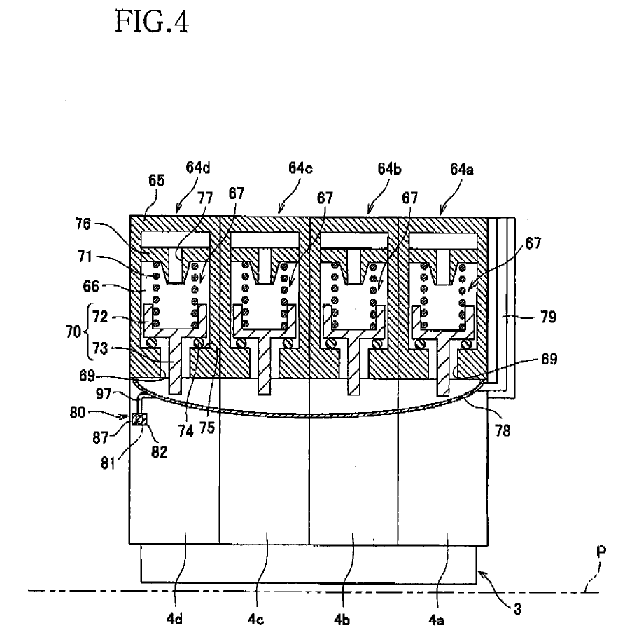

As shown in FIGS. 1 and 3, each of the exhaust units 64a through 64d is provided on one end of a corresponding one of the sub tanks 4a through 4d that is opposite to the tube joint 20 so as to exhaust the air bubbles that remain in the sub tanks 4a through 4d. As shown in FIG. 4, the four exhaust units 64a through 64d correspond to the respective four sub tanks 4a through 4d each of which accommodates a respective one of the four colors of inks. As shown in FIG. 3, when the inkjet head 3 is positioned in the recording area in which images can be recorded on the recording sheet P, the four exhaust units 64a through 64d are positioned at a position above the sheet-supply roller 25 for feeding the recording sheet P in the sheet feed direction. In other words, as shown in FIG. 1, the four exhaust units 64a through 64d are aligned with the sheet-supply roller 25 as seen in a vertical direction or in a plan view.

Since the four exhaust units 64a through 64d corresponding to the four sub tanks 4a through 4d have basically the identical structures with each other, hereinafter, one of the exhaust units 64a through 64d will be representatively described and is referred to as “the exhaust unit 64” when required. As shown in FIGS. 3 and 4, the exhaust unit 64 includes: a case 65 as a valve housing that is attached to an outer surface of a wall portion which forms the vertical passage 61 of the sub tank 4 inside thereof a communication passage 66 that is formed inside of the case 65 and diverges from the vertical passage 61; and the on-off valve 67 which selectively opens and closes the communication passage 66.

In a side wall of an upper end portion of the case 65, there is formed a through hole 68. The communication passage 66 diverges or branches from an upper end portion of the vertical passage 61 which is communicated with an upper portion of the ink reservoir chamber 60 through the communication passage 62, and extends from the through hole 68 to a exhaust hole 69 that is formed in a lower end portion of the case 65.

The on-off valve 67 includes a valve member 70 which is arranged to be movable in the communication passage 66 in a vertical direction and can close the exhaust hole 69, and a coil spring 71 as an elastic member which biases the valve member 70 downward or in a direction in which the exhaust hole 69 is closed by the valve member 70.

The valve member 70 includes: a valve element 72 which is movable in the vertical direction in the communication passage 66 so as to be seated on or lifted from a valve seat 75 which is formed in the communication passage 66 or in a circumference of the exhaust hole 69 and has a larger outside diameter than an inside diameter of the exhaust hole 69; and a valve rod 73 which extends downward from the bottom portion of the valve element 72. The valve element 72 and the valve rod 73 are movable integrally with each other. The outside diameter of the valve element 72 is smaller than an inside diameter of the communication passage 66 such that ink can flow through a space formed between the valve element 72 and an inner circumferential surface of a side wall portion of the case 65 that defines the communication passage 66. An annular seal member 74 is attached to a lower surface of the valve element 72. When the valve element 72 comes into contact with the valve seat 75 via the seal member 74, the valve element 72 closes an upper one of opposite openings of the exhaust hole 69 so as to close the communication passage 66. When the valve element 72 is held in contact with the valve seat 75, the valve rod 73 protrudes downward from a lower one of opposite openings of the communication passage 66 or a lower one of the opposite openings of the exhaust hole 69, i.e., extends downward through the exhaust hole 69 so as to protrude from a lower end of the case 65.

A spring retainer 76 is provided in an inner space of an upper end portion of the case 65. The spring retainer 76 has a through hole 77, and an upper space of the case 65 and a lower space thereof that are defined by the spring retainer 76 are in communication with each other through the through hole 77. The coil spring 71 is arranged between the spring retainer 76 and the valve element 72 in a state of contraction, and biases the valve element 72 downward or in a direction in which the valve element 72 is seated on the valve seat 75.

Further, as shown in FIGS. 3 and 4, there is disposed an exhaust cap 78 which is fluid-tightly attached to a peripheral portion of a lower surface common to the four exhaust units 64a through 64d corresponding to the four sub tanks 4a through 4d. The exhaust cap 78 is formed of a flexible material such as a resin material or a rubber material and consists of a membranous or film member. A peripheral portion of the exhaust cap 78 is fixed, by appropriate means such as adhesive, to the peripheral portion of the lower surface common to the four cases of the four exhaust units 64a through 64d. The four exhaust holes 69 of the communication passages 66 are opened in the common lower surface, and the exhaust cap 78 always fluid-tightly covers lower openings of the exhaust holes 69 (the communication passages 66).

While one of opposite ends of a connecting tube or passage 79 is connected to the exhaust cap 78, the other thereof is connected to the exhaust tube 21 at the tube joint 20, as shown in FIG. 1. As mentioned before, one end portion of the exhaust tube 21 that is located opposite to a side of the tube joint 20 or the sub tanks 4a through 4d is connected to the suction pump 14 via the switch unit 15. In other words, the communication passage 66 of the exhaust units 64 that diverges from a passage in the sub tank 4 is connected to the suction pump 14 via the exhaust cap 78, the connecting passage 79, the exhaust tube 21, and the switch unit 15.

As shown in FIGS. 3 and 4, the four exhaust units 64a through 64d are located at a height position considerably higher than that of the droplet ejecting surface of the inkjet head 3 or the lower surface thereof in which a plurality of droplet ejecting openings of the nozzles 40 are arranged. In other words, the exhaust cap 78 that is disposed at the lower end surfaces of the exhaust units 64a through 64d is located at a height position higher than that of the droplet ejecting openings of the nozzles 40. Accordingly, the recording sheet P that is fed in the sheet feed direction at a height position lower than the lower surface of the inkjet head 3 is prevented from coming into contact with the exhaust cap 78. Further, when inks that are stuck to the droplet ejecting surface of the inkjet head 3 are wiped off by the wiper 16 after inks are forcedly sucked and removed from the nozzles 40 as a part of a recovery operation of the droplet-ejecting performance by the maintenance device 7, it cannot occur that the wiper 16 comes into contact with the exhaust cap 78 and the inks are stuck to an outer surface of the exhaust cap 78.

Furthermore, since the exhaust cap 78 is located at the position higher than that of the droplet ejecting surface of the inkjet head 3, when the inkjet head 3 is positioned at the recording area to be opposed to the recording sheet P, as shown in FIGS. 1 and 3, an arrangement relation can be realized such that the sheet-supply roller 25 is located below the exhaust units 64a through 64d, and the sheet-supply roller 25 and the exhaust units 64a through 64d are aligned with each other as seen in the vertical direction.

When the above-mentioned arrangement relation is adopted, it is unnecessary that the sheet-supply roller 25 is located apart from the sub tanks 4a through 4d (the inkjet head 3) on an upstream side of the printer 1 in the sheet feed direction (on a left-hand side in FIG. 3). In other words, a distance between the sheet-supply roller 25 and the sheet-discharge roller 26 cannot become large when the exhaust units 64a through 64d are disposed in the sub tanks 4a through 4d. Therefore, the printer 1 can be downsized even when the exhaust units 64a through 64d are disposed in the sub tanks 4a through 4d. Further, ruffling (rippling) of the recording sheet P during feeding thereof, which considerably depends on the distance between the sheet-supply roller 25 and the sheet-discharge roller 26, can be restrained, and as a result, lowering of a quality of recording (printing) due to the ruffling of the recording sheet P is prevented.

Furthermore, as shown in FIG. 4, the exhaust cap 78 is connected via a tube 97 to an atmosphere communication portion 80 which has an inner space of the exhaust cap 78 (an exhaust-passage-side space) communicate with the atmosphere. The atmosphere communication portion 80 includes an communication opening 81 which opens to the atmosphere (the outside), a main body 87 which is connected to the exhaust cap 78 through the tube 97, and an air permeating film or membrane 82 which covers the communication opening 81. The air permeating film 82 is a film, e.g., a porous fluoroethylene resin film, which permits air to permeate therethrough and prevents liquid (ink) and solid from permeating therethrough. By the air permeating film 82, while air of the atmosphere outside of the exhaust cap 78 is permitted to flow into the inner space of the exhaust cap 78, inks that remain in the inner space of the exhaust cap 78 are prevented from leaking out from the communication opening 81 of the atmosphere communication portion 81.

As mentioned before, the maintenance device 7 includes the valve operating device 83 which operates the on-off valve 67 of the exhaust unit 64, as shown in FIG. 1.

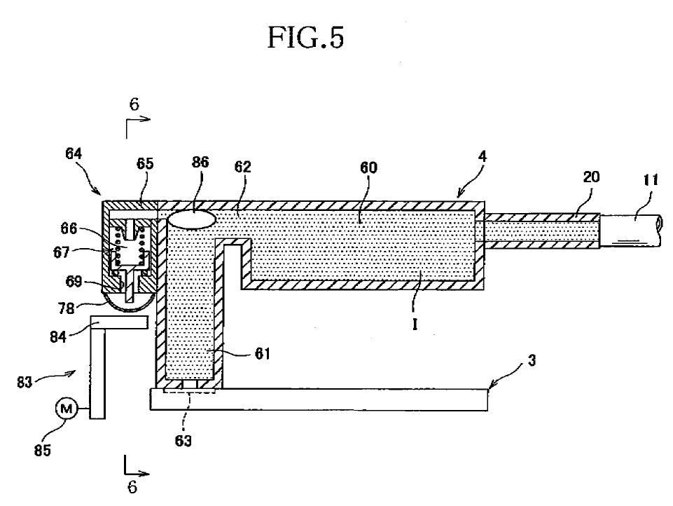

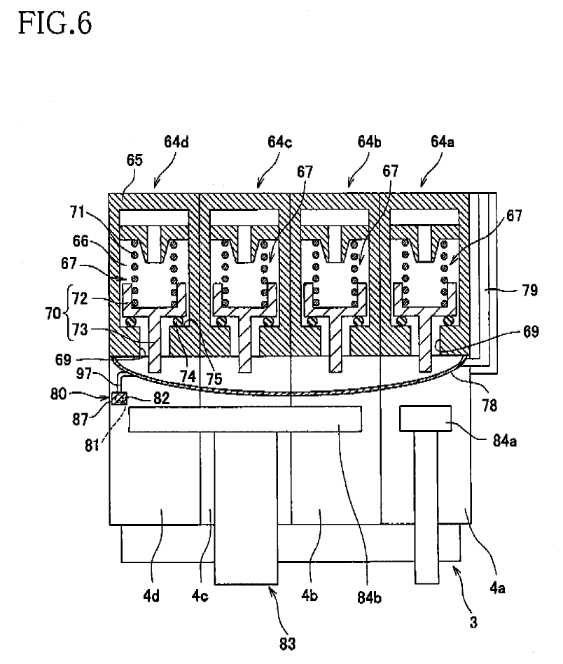

As shown in FIGS. 5 and 6, the valve operating device 83 includes a plurality of (in the present embodiment, two) pressing portions 84a, 84b and two pressing-portion drive motors 85a, 85b which drive the respective pressing portions 84a, 84b to move up and down, i.e., move to an opening valve position to press the valve rod 73 so as to open the on-off valve 67 and a closing valve position to be retracted from the valve rod 73 so as to close the on-off valve 67. As shown in FIG. 6, when the sub tanks 4a through 4d that are carried by the carriage 2 with the inkjet head 3 are positioned at the maintenance position, the pressing portion 84a is opposed to the lower end surface, i.e. the valve rod 73 of the exhaust unit 64a for a black ink through the exhaust cap 78. The pressing portion 84b is opposed to the respective lower end surfaces, i.e. the respective valve rods 73 of the three exhaust units 64b through 64d for color inks through the exhaust cap 78. A length of the pressing portion 84b for the color inks in the scanning direction or in a widthwise direction of the exhaust unit 64 is larger than that of the pressing portion 84a for the black ink, and the pressing portion 84b extends horizontally over the three exhaust units 64b through 64d in the scanning direction.

The pressing portions 84a, 84b are independently driven by the corresponding pressing-portion drive motors 85a, 85b to move upward or move to the opening valve position such that the on-off valve 67 is operated in a direction in which the communication passage 66 is opened. In other words, the pressing portions 84a, 84b press the respective valve rods 73, protruding from the lower end surface of the case 65, of the respective on-off valves 67 corresponding to the exhaust units 64a through 64d upward through the exhaust cap 78 or from the outside thereof. At this time, the valve element 72 of the on-off valve 67 is moved upward against a biasing force by the coil spring 71, so that the valve element 72 is lifted from the valve seat 75 and the exhaust hole 69 that is located in a lower end of the communication passage 66 is opened. On the other hand, when the pressing portions 84a, 84b are independently driven by the pressing-portion drive motors 85a, 85b to move downward or to the closing valve position, the respective on-off valves 67 are operated in a direction to be closed. In other words, when the pressing portions 84a, 84b are retracted from the respective valve rods 73 of the exhaust units 64a through 64d, the respective valve elements 72 of the respective on-off valves 67 are biased by the coil springs 71 to move downward to be seated on or be in close contact with the valve seat 75 so as to close the exhaust holes 69.

Since the exhaust cap 78 is formed of the flexible material, the exhaust cap 78 is easily deformed or bent in a case of being influenced by an outer force (when the exhaust cap 78 receives an outer force) such that the valve operating device 83 is allowed to operate the on-off valve 67. Accordingly, up-down movements of the pressing portions 84a, 84b are certainly transmitted to the respective valve elements 72 even through the exhaust cap 78, so that the on-off valves 67 can be surely operated to be opened or closed.

In a state in which the on-off valve 67 is operated to be opened by the valve operating device 83 such that the communication passage 66 in the exhaust unit 64 is opened, when air in the inner space of the exhaust cap 78 is sucked by the suction pump 14 through the connecting passage 79 and the exhaust tube 21 (shown in FIG. 1), a pressure in the inner space of the exhaust cap 78 is decreased. Accordingly, the air bubbles 86 that remain in the sub tank 4 are exhausted or removed from the communication passage 66 to the exhaust cap 78. In the present embodiment, a passage consisting of the connecting passage 79 and the exhaust tube 21, one end of which is connected to the exhaust cap 78 while the other end of which is connected to the suction pump 14, corresponds to an exhaust passage which is communicable with the ink supply passage (the liquid supply passage) to exhaust the air bubbles from the sub tanks 4a through 4d or the ink supply passage.

Hereinafter, the control device 8 that controls various operations of the printer 1 will be described. Referring to the block diagram of FIG. 7, the control device 8 includes a CPU (Central Processing Unit), a ROM (Read Only Memory) in which various programs and data are stored for controlling operations of the printer 1, and a RAM (Random Access Memory) in which the data that are processed in the CPU are temporarily stored.

The control device 8 functionally includes a recording control portion 91 and a maintenance control portion 92. The recording control portion 91 controls, based on data inputted from an input device 90 such as a personal computer (PC), the carriage drive motor 19 that drives a reciprocating movement of the carriage 2 (shown in FIG. 1), the head driver 53 of the inkjet head 3, the sheet-supply motor 27 that drives the sheet-supply roller 26, the sheet-discharge motor 28 that drives the sheet-discharge roller 26, and so on such that images are recorded on the recording sheet P.

The maintenance control portion 92 controls the cap drive motor 94 that drives the suction cap 13 to move up and down, the switch unit 15, and the suction pump 14 such that an ink suction operation is performed in which inks are sucked from the plurality of nozzles 40 of the inkjet head 3. More precisely, first, the suction cap 13 is driven by the cap drive motor 94 to move up to a capping position in which the suction cap 13 covers the nozzles 40. Next, by the switch unit 15, the suction pump 14 is switched to be in communication with the suction cap 13 (the first cap portion 13a or the second cap portion lab). Then, when the suction pump 14 is driven such that the inner space of the suction cap 13 is decompressed, inks are exhausted or removed from the nozzles 40 that are covered by the suction cap 13 to the inner space of the suction cap 13. Due to the above-mentioned ink suction operation, the inks in the nozzles 40 that increase viscosity due to drying thereof and air in the inkjet head 3 can be removed from the nozzles 40.

The maintenance control portion 92 also controls the pressing-portion drive motors 85a, 85b that drive the respective on-off valves 67 of the exhaust units 64a through 64d, the switch unit 15, and the suction pump 14 such that an air-bubbles exhaust (suction) operation is performed in which the air bubbles that remain in the sub tanks 4a through 4d are sucked and exhausted through the exhaust units 64a through 64d.

First, the maintenance control portion 92 controls the switch unit 15 to have the suction pump 14 communicate with the exhaust tube 21 (the exhaust units 64a through 64d). In this state, as shown in FIGS. 5 and 6, in each of the exhaust units 64a through 64d, the valve element 72 that is disposed in the communication passage 66 is biased downward by the coil spring 71 so as to close the communication passage 66 or the exhaust hole 69.

Next, the maintenance control portion 92 controls the pressing-portion drive motor 85 of the valve operating device 83 to drive the pressing portion 84 to move upward. At this time, upper surface (pressing surface) of the pressing portion 84 is come into contact with lower end of the valve rod 73 extruding from the corresponding valve element 72, however, lower end surface of the exhaust unit 64 having the lower opening of the exhaust hole 69 through which the valve rod 73 extends is fluid-tightly covered by the flexible exhaust cap 78. Therefore, the pressing portion 84a presses the valve rod 73 upward through the exhaust cap 78 or from the outside of the exhaust cap 78. Then, the valve element 72 which is connected (fixed) to an upper end of the valve rod 73 is moved upward against the biasing force by the coil spring 71 and away from the valve seat 75 so as to open the communication passage 66 or the exhaust hole 69.

In the present embodiment, the maintenance control portion 92 may control the two pressing-portion drive motors 85a, 85b to concurrently drive the corresponding pressing portions 84a, 84b to move upward, or may control one of the pressing-portion drive motors 85a, 85b to drive a corresponding one of the pressing portions 84a, 84b to move upward. In other words, The respective communication passages 66 of the four exhaust units 64a through 64d may be concurrently opened, or only a corresponding communication passage 66 of either one of the exhaust unit 64a for the black ink and the three exhaust units 64b through 64d for the color inks may be opened.

Further, in the air-bubbles exhaust operation, the maintenance control portion 92 operates the suction pump 14 to suck air in the inner space of the exhaust cap 78 via the exhaust tube 21 and the connecting passage 79. As a pressure in the inner space of the exhaust cap 78 is decreased, the air bubbles 86 that remain in an upper end portion of the sub tank 4 are moved to the communication passage 66 and exhausted to the exhaust cap 78.

The air bubbles that are put into the ink supply passage extending from the ink cartridge 6 to the inkjet head 3 tend to remain in the upper portion of the ink reservoir chamber 60 and the upper end portion of the vertical passage 61. In the present embodiment, as shown in FIG. 5, the upper portion of the ink reservoir chamber 60 is in communication with the communication passage 66 in the exhaust unit 64 via the upper end portion of the vertical passage 61. Therefore, (large) air bubbles that remain in the upper portion of the ink reservoir chamber 60 can be easily exhausted from the communication passage 66 to the exhaust cap 78.

During the air-bubbles exhaust operation by the suction pump 14, not only the air bubbles 86 but also ink flow out from the sub tank 4 to the communication passage 66. In the present embodiment, the lower opening of the exhaust hole 69 that is located in a lower end of the communication passage 66 is always fluid-tightly covered by the exhaust cap 78. Accordingly, the ink that flows out from the communication passage 66 is received by the exhaust cap 78. Further, since the exhaust cap 78 is fixed to the exhaust unit 64, i.e., is not detached from the same 64, the ink that is exhausted along with the air bubbles is not scattered or spread around the printer 1. Therefore, for example, when the inkjet head 3 is positioned at the recording area at which the inkjet head 3 is opposed to the recording sheet P, it is prevented that the ink is stuck to the sheet-supply roller 25 that is positioned below the exhaust unit 64 and the recording sheet P that is fed by the sheet-supply roller 25 is soiled with the ink.

The maintenance control portion 92 then controls the pressing-portion drive motor 85 to drive the pressing portion 84 (e.g., the pressing portion 84a) to move downward. At this time, the pressing portion 84a is detracted (moved away) from the exhaust cap 78 and the valve element 72 is released from a pressed state in which the valve element 72 is pressed by the pressing portion 84a, so that the valve element 72 is pressed on the valve seat 75 by the biasing force of the coil spring 71 such that the communication passage 66 is closed by the valve element 72. The air-bubbles exhaust (suction) operation as a first suction mode for exhausting the air bubbles from the sub tank 4 is thus ended.

Right after the air-bubbles exhaust operation is ended, the ink that flows out with the air bubbles 86 from the sub tank 4 to the communication passage 66 remains in the inner space of the exhaust cap 78. Therefore, as a second suction mode, in a state in which the communication passage 66 is closed by the on-off valve 67, the maintenance control portion 92 operates the suction pump 14 again to suck the ink that remains in the exhaust cap 78.

In the second suction mode, as shown in FIG. 6, the inner space of the exhaust cap 78 is in communication with the atmosphere via the atmosphere communication portion 80. Therefore, when air in the inner space of the exhaust cap 78 is sucked by the suction pump 14 in the state in which the communication passage 66 is closed by the on-off valve 67; air of the atmosphere flows from the atmosphere communication portion 80 into the inner space of the exhaust cap 78. Accordingly, while the air of the atmosphere is introduced from the atmosphere communication portion 80, the ink that remains in the exhaust cap 78 can be surely sucked by the suction pump 14. Further, the air permeating film 82 as a leaking-preventing portion which permits only air to permeate therethrough is disposed to cover the communication opening 81 of the atmosphere communication portion 80, so that the ink in the inner space of the exhaust cap 78 is prevented from leaking to the atmosphere through the atmosphere communication portion 80.

In the first suction mode for exhausting the air bubbles that is implemented in a state in which the communication passage 66 is opened by the on-off valve 67, the ink in the sub tank is sucked to the communication passage 66. Therefore, when a suction volume or amount is large or the ink is strongly sucked, it is possible that a meniscus formed in the nozzles 40 of the inkjet head 3 which is in communication with the vertical passage 61 of the sub tank 4 is broken. Accordingly, it is preferable that in the maintenance control portion 92, when the first suction mode is implemented, the suction amount by the suction pump 14 is determined to be relatively small.

On the other hand, in the second suction mode for exhausting ink remainder in the exhaust cap 78 that is implemented in the state in which the communication passage 66 is closed by the on-off valve 67, even when the suction amount by the suction pump 14 is made large, the above-mentioned problem such that the meniscus formed in the nozzles 40 is broken does not occur. Therefore, in the maintenance control portion 92, when the second suction mode is implemented, the suction amount by the suction pump 14 in the second suction mode is determined to be larger than the suction amount by the suction pump 14 in the first suction mode.

Hereinafter, there will be described modified embodiments in which the illustrated embodiment as a first embodiment is modified with various changes. In the modified embodiments, only elements that are not identical with those in the first embodiment will be described. The identical elements will be denoted by the reference numerals used in the first embodiment, and illustration thereof is omitted.

### Second Embodiment

In the illustrated embodiment, as shown in FIGS. 4 and 6, in the atmosphere communication portion 80 through which the inner space of the exhaust cap 78 and the atmosphere are communicated with each other, the air permeating film 82 is disposed as the leaking-preventing portion by which the ink in the exhaust cap 78 is prevented from being leaked out. However, the leaking-preventing portion may adopt different structures.

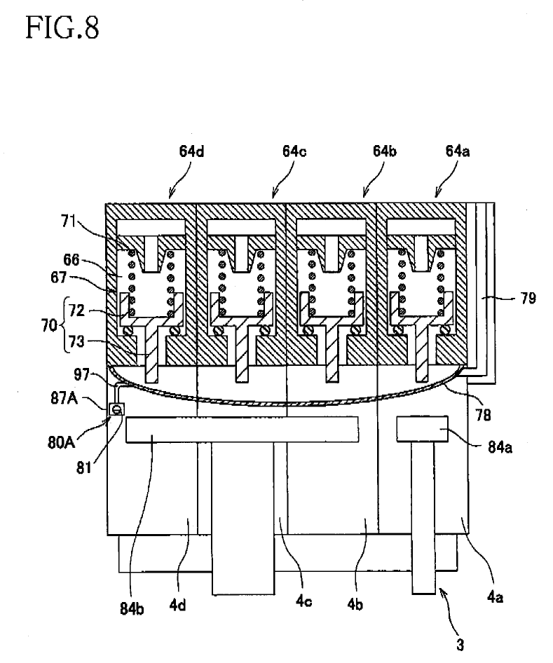

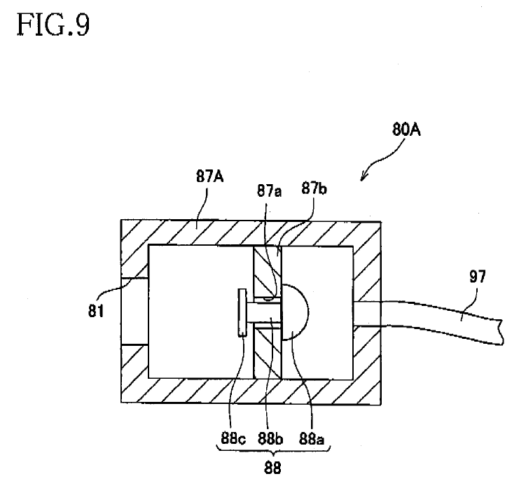

For example, as shown in FIGS. 8 and 9, in the atmosphere communication portion 80A, there may be disposed a one-way valve 88 which permits air of the atmosphere to flow into (an inside of) the inner space of the exhaust cap 78 from the outside thereof and prevents the air and the liquid from flowing out in a direction from the inside of the exhaust cap 78 to the outside thereof FIG. 9 shows an example of a specific structure of the one-way valve 88. In the second embodiment, the atmosphere communication portion 80A includes the communication opening 81 which opens to the outside (the atmosphere), a main body 87A which is connected to the inner space of the exhaust cap 78 via the tube 97, and the one-way valve 88 which is disposed in an inside of the main body 87A.

In the inside of the main body 87A, a partition wall 87b which has a through hole 87a is disposed, and by the partition wall 87b, a space on a side of the communication opening 81 that is in communication with the atmosphere (a left-hand side space in FIG. 9) and a space on a side of the tube 97 or the exhaust cap 78 (a right-hand side space in FIG. 9) are defined and spaced apart from each other. Further, the one-way valve 88 includes: a valve element 88a which has an umbrella-like structure and has a larger outside diameter than an inside diameter of the through hole 87a; a valve rod 88b which is disposed to be movable integrally with (is connected to) the valve element 88a and extends through the through hole 87a; and a retaining portion 88c which is disposed on one of opposite ends of the valve rod 88b that is opposite to the valve element 88a and prevents the valve rod 88b from coming (falling) out from the through hole 87a. The valve element 88a is disposed in the space on the side of the tube 97 (the space that is close to the tube 97).

In the present embodiment, when air in the exhaust cap 78 is sucked by the suction pump 14 and a pressure in the right-hand side space of the main body 87A which is in communication with the inner space of the exhaust cap 78 via the tube 97 is made lower than the atmospheric pressure, due to a difference in pressure between the lowered pressure in the right-hand side space of the main body 87A and the atmospheric pressure, the valve element 88a is moved rightward in FIG. 9 or in a direction that is closer to the tube 97 so as to open the through hole 87a. As a result, air which flows into the main body 87A through the communication hole 81 flows to the exhaust cap 78 via the tube 97. On the other hand, when the pressure in the exhaust cap 78 is larger than the atmospheric pressure, due to the difference in pressure between the pressure in the right-hand side space of the main body 87A and the atmospheric pressure, the valve element 88a is fluid-tightly in close contact with the partition wall 87b so as to close the communication hole 87a. It is thus prevented that ink flows out from the side of the exhaust cap 78 to the atmosphere through the communication opening 81.

### Third Embodiment

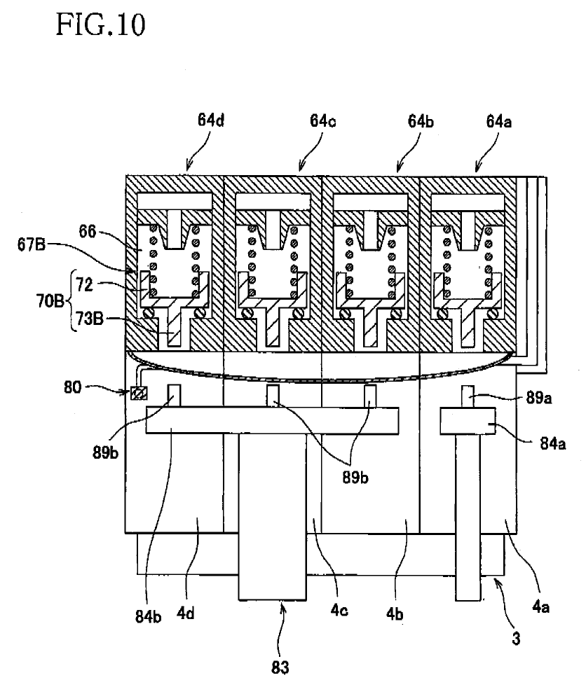

It is not necessary that the valve rod 73 of the on-off valve 67 protrudes from the lower end of the exhaust unit 64 in a state in which the communication passage 66 is closed by the valve element 72. In other words, as shown in FIG. 10 as a third embodiment, a full length of a valve rod 73B of a valve member 70B of the on-off valve 67B in an axis direction of the valve rod 73B may be accommodated in the exhaust unit 64. In the third embodiment, in the pressing portions 84a, 84b of the valve operating device 83, projecting portions 89a, 89b are respectively disposed for pressing respective lower ends of the valve rods 7313 in the exhaust units 64a through 64d upward or in a direction in which the on-off valve 67B is opened.

### Fourth Embodiment

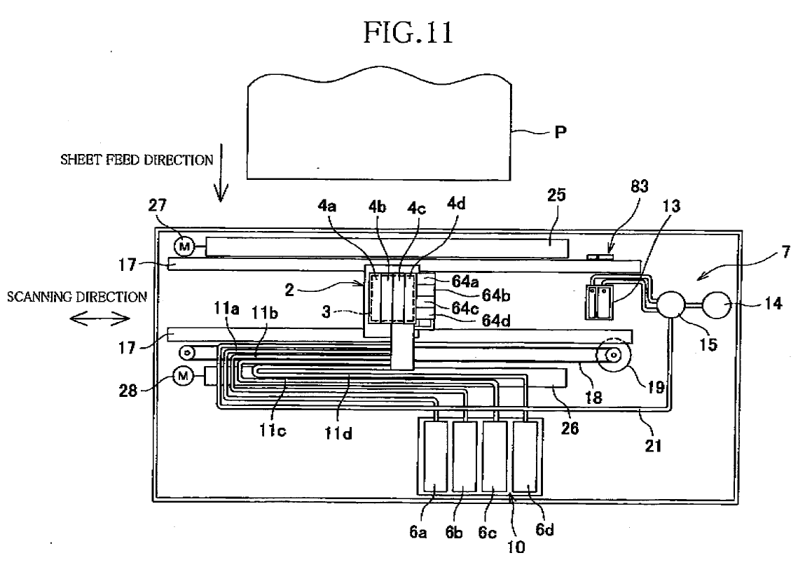

An attachment position of the exhaust units 64a thorough 64d is not necessarily located on the upstream side (on a side of the sheet-supply roller 25) relative to the sub tank 4 in the sheet feed direction, and the exhaust units 64a through 64d may be located on one side in the scanning direction relative to the sub tank 4. For example, as shown in FIG. 11 as a fourth embodiment, the four exhaust units 64a through 64d are arranged in the sheet feed direction on a side portion of the sub tank 4d that is located on the most right-hand end in the scanning direction among the four sub tanks 4a through 4d.

### Fifth Embodiment

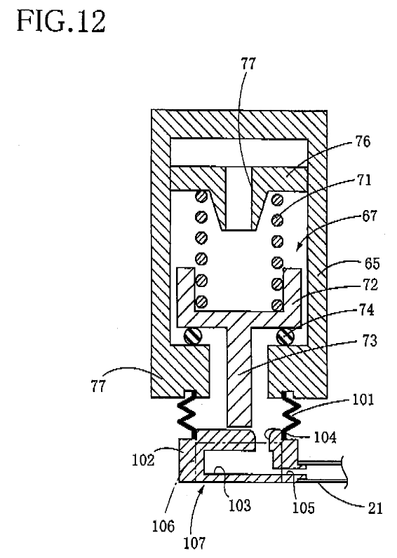

The exhaust cap 78 that is integrally formed of a flexible membranous member can enjoy a reduced cost of manufacturing, however, an exhaust cap is not limited to this. For example, as shown in FIG. 12 as a fifth embodiment, an exhaust cap may consist of a combination of a bellows 101 and a movable member 102. The movable member 102 is connected to the case 65 through the bellows 101 and can be moved toward and away from the case 65, accompanied by extension and contraction of the bellows 101. The movable member 102 includes: a through hole 103 which penetrates through the movable member 102 in a direction perpendicular to an axis direction of the valve rod 73; an inlet 104 through which the through hole 103 and an inner space of the bellows 101 are communicated with each other; and an outlet 105 which is connected to the exhaust tube 21. Each of opposite openings of the through hole 103 is covered by an air permeating film or membrane 106 to form a chamber inside the movable member 102, and an atmosphere communication portion 107 is constituted by the air permeating film or membrane 106. When the pressing portion 84 of the valve operating device 83 presses the movable member 102 upward, the movable member 102 presses the valve rod 73 so as to open the on-off valve 67. In a case where at least one of a limiting device which limits a range in which the movable member 102 is distanced from the case 65 and a guide device which guides a movement of the movable member 102 relative to the case 65 is provided, an operation of the movable member 102 can be more stabilized.

The illustrated embodiments are preferred embodiments of the present invention that are applied to an inkjet printer in which ink is ejected toward a recording sheet such that images are recorded on the recording sheet, however, the present invention is not limited to the illustrated embodiments only. The present invention is applicable to various types of droplet ejecting apparatus which eject various kinds of liquid to an object, depending on the intended use. Further, it is to be understood that the present invention may be embodied with various changes and improvements that may occur to a person skilled in the art, without departing from the spirit and scope of the invention defined in the appended claims.

What is claimed is:

1. A droplet ejecting apparatus comprising:
a droplet ejecting head which has at least one nozzle through which a droplet of a liquid is ejected;
a liquid supply passage for supplying the liquid to the droplet ejecting head;
an exhaust passage which is communicable with the liquid supply passage to exhaust bubbles in the liquid supply passage;
an on-off valve which selectively opens or closes an communication passage that is provided between the liquid supply passage and the exhaust passage;
an exhaust cap which fluid-tightly closes one of opposite openings of the communication passage that is close to the exhaust passage, and which is connected to one of opposite ends of the exhaust passage that is close to the communication passage;
a suction device which is connected to an other end of the exhaust passage;
a switching device which indirectly operates the on-off valve through the exhaust cap from an outside thereof to selectively open or close the on-off valve; and
a control device which controls the droplet ejecting head, the suction device, and the switching device.

2. The droplet ejecting apparatus according to claim 1, wherein the exhaust cap has a flexibility and is bent such that the switching device is allowed to operate the on-off valve.

3. The droplet ejecting apparatus according to claim 2,
wherein the on-off valve includes:
a valve housing which has the communication passage and a valve seat that is provided in the communication passage;
a valve element which can be seated on or lifted from the valve seat;
an elastic member which biases the valve element in a direction in which the valve element is seated on the valve seat; and
a valve rod which extends from the valve element, and
wherein the switching device operates the valve rod through the exhaust cap to move against an elastic force by the elastic member so as to open the on-off valve.

4. The droplet ejecting apparatus according to claim 3, wherein the valve rod protrudes from the one of opposite openings of the communication passage.

5. The droplet ejecting apparatus according to claim 3, wherein the exhaust cap consists of a membranous member whose peripheral portion is fluid-tightly fixed to a peripheral portion of a surface in which the one of opposite openings of the communication passage that is provided in the valve housing of the on-off valve is opened.

6. The droplet ejecting apparatus according to claim 3, wherein the switching device includes:
a pressing portion which is opposed to the valve rod through the exhaust cap; and
a driving portion which causes the pressing portion to move between an opening valve position to press the valve rod so as to open the on-off valve and a closing valve position to be lifted from the valve rod so as to close the on-off valve.

7. The droplet ejecting apparatus according to claim 1,
wherein the control device has a first suction mode, and
wherein in the first suction mode, the switching device operates the on-off valve from an outside of the exhaust cap to open the communication passage,
and next, the bubbles in the liquid supply passage are sucked by the suction device through the exhaust passage to be discharged into the exhaust cap,
and then, the switching device operates the on-off valve from the outside of the exhaust cap to close the communication passage.

8. The droplet ejecting apparatus according to claim 7, wherein the control device further has a second suction mode in which, in a state in which the communication passage is closed by the on-off valve after implementing of the first suction mode, a liquid that remains in the exhaust cap is sucked by the suction device.

9. The droplet ejecting apparatus according to claim 8, wherein a suction amount by the suction device in the second suction mode that is implemented in the state in which the communication passage is closed by the on-off valve is larger than the suction amount in the first suction mode that is implemented in a state in which the communication passage is open.

10. The droplet ejecting apparatus according to claim 1, further comprising an atmosphere communication portion which has an exhaust-passage-side space that is a space disposed in a side of the exhaust passage relative to the on-off valve communicate with an atmosphere, and
wherein the atmosphere communication portion includes a leaking-preventing portion which prevents a liquid in the exhaust-passage-side space from leaking to the atmosphere.

11. The droplet ejecting apparatus according to claim 10, wherein the leaking-preventing portion includes an air permeating film which permits an air to permeate therethrough and prevents a liquid from permeating therethrough.

12. The droplet ejecting apparatus according to claim 10, wherein the leaking-preventing portion includes a one-way valve which permits air of the atmosphere to flow into an inside of the exhaust-passage-side space from the outside thereof and prevents the air and the liquid from flowing out in a direction from the inside of the exhaust-passage-side space to the outside thereof.

13. The droplet ejecting apparatus according to claim 1, wherein the exhaust cap is located at a position higher than a position of a droplet ejecting opening of the nozzle.

14. The droplet ejecting apparatus according to claim 1,
wherein the liquid supply passage includes a liquid reservoir chamber which accommodates the liquid, and
wherein the exhaust passage is communicable with the liquid supply passage through the communication passage that diverges from an upper portion of the liquid reservoir chamber.

15. The droplet ejecting apparatus according to claim 1, further comprising a medium feeding device which feeds a recording medium, and
wherein the droplet ejecting head has a plurality of nozzles, and
wherein by ejection of the droplet through the plurality of nozzles, an image is recorded on the recording medium which is fed by the medium feeding device.

16. The droplet ejecting apparatus according to claim 15, further comprising a head moving device which causes the droplet ejecting head to move in a direction perpendicular to a direction of feeding of the recording medium by the medium feeding device, and
wherein the on-off valve and the exhaust cap are moved by the head moving device along with the droplet ejecting head, and the suction device is provided in a fixed position,
wherein the exhaust cap and the suction device are always connected to each other through a flexible tube that is elastically deformable with moving of the exhaust cap, and
wherein the flexible tube forms at least a part of the exhaust passage.

17. The droplet ejecting apparatus according to claim 16, wherein the switching device is provided in a maintenance position that is apart from a recording area in which an image recording is performed by the droplet ejecting head.
